(19) United States
(12) Patent Application Publication
(10) Pub. No.: US 2005/0111276 A1
(43) Pub. Date: May 26, 2005

(54) Page splitting mechanism for transparent distributed shared memory implementations in process migration cluster environments

(75) Inventors: Moshe Israel Bar, Cupertino, CA (US); Offer Markovich, Kfar-Sava (IL)

Correspondence Address: Kevin D. McCarthy;Roach Brown McCarthy & Gruber, P.C., 420 Main Street - 1620 Liberty Building, Buffalo, NY, 14202, US

(73) Assignee: Qlusters Software Israel Ltd.

(21) Appl. No.: 10/985,504

(22) Filed: Nov. 10, 2004

(30) Foreign Application Priority Data
Nov. 20, 2003 (IL) 159001

(51) Int. Cl. G11C 7/00

(52) U.S. Cl. 365/203

(57) ABSTRACT

A method and system for identifying and eliminating false VM-page sharing in DSM systems. False VM-page sharing instances is determined whenever the same VM-page is required for accessing different objects residing on that VM-page. The falsely shared VM-pages are split into a plurality of smaller VM-pages, such that each smaller VM-page includes at least one of the objects. The falsely shared VM-pages are set invalid and whenever a request for one of the falsely shared VM-pages is received, the system determines which object need to be accessed and one of the smaller VM-pages is provided accordingly.

### FIELD OF THE INVENTION

The present invention relates to the field of shared memory in Distributed Shared Memory implementations. More particularly, the invention relates to identification and elimination of false sharing of virtual memory pages.

### BACKGROUND OF THE INVENTION

Heretofore, no unified memory models for shared memory regions existed in single system image clusters where the prevalent load balancing mechanism is represented by demand-paging process migration.

A key problem when implementing true commodity computing for enterprise business applications is the wide-spread use of IPC (Inter-Process Communication) communication between execution instances within the application. If such execution instances are migrated to remote nodes in a commodity computing cluster, they need some sort of mechanism to attach the remote shared memory segment to their address space. For instance Oracle's Oracle9i™ database uses standard POSIX (Portable Operating System Interface) shared memory segments to communicate to related client processes and instance management threads. In Linux, shared memory segment is handled through the same mechanism as for files (i.e., using inodes). However, shared memory is not file mapped in Linux (as opposed to standard BSD style shared memory).

DSM suffers mostly from false sharing of virtual memory pages, which occurs when different objects required by distinctly different logical instances (i.e., processes on different nodes) reside on the same memory container (in this case a virtual memory page), as illustrated in FIG. 1. In this example the Cluster network nodes Nd2, Nd3, and Ndx, require objects Obj1-1, Obj1-2, and Obj1-k, respectively, residing on Virtual Memory (VM) page Pg-1, maintained in Cluster node Nd1. Although different objects of the VM memory are required, the same page can not be concurrently accessed for writing by more than one process at any given time.

Typically, access for writing to a VM-page is granted to only one node, for example Nd2, while a queue of all other waiting requests is maintained e.g., Nd3, . . . , and Ndx.

The requested VM-page (e.g., Pg-1) should be copied to the VM of the requesting node (e.g., Nd2), if it does not already possess an updated copy of this VM-page. When the accessing node completes the tasks related to the VM-page, all copies of the VM-page in the Cluster should be updated before the access to this VM-page can be granted to other requesting nodes.

Since the different objects Obj1-1, Obj1-2, and Obj1-k, reside on the same VM-page, contention arises from having to send the same VM-page back and forth between nodes even though the contention does not exist at a logic object level (i.e., each object is requested by a different node).

Modern DSM systems rely on either non-strict VM-pages release consistencies (e.g., “Lazy Release Consistency”, Pete Keleher at al, Proc. of the 19th Annual Int'l Symp. on Computer Architecture) and/or on super-fast interconnect to scale up the number of instantiating nodes in a cluster (e.g., InfiniBand, Myrinet, or Dolphin interconnects). Both approaches however have proven to delay the point of saturation of the inherent DSM algorithms instead of generally speeding up DSM operation.

An additional known problem in DSM systems is the access VM-page faults on temporarily unavailable memory containers (i.e., swapped out or remotely-only available VM-pages). Since temporarily unavailable VM-pages cannot be made available at the top of the FIFO queue, where they logically supposed to be, but rather at the bottom of the FIFO queue, where they do not resolve dependency wait states, they will resolve to wrong VM-pages.

The prior art methods have not yet provided satisfactory solutions to the problems of false sharing and access faults of VM-pages in DSM implementations.

It is an object of the present invention to provide a method and system for improving performance of Distributed Shared Memory (DSM) for clusters implementation, which are independent of the cluster interconnects and their latencies.

It is another object of the present invention to provide a method and system for improving the scalability and the resource utilization for resources like interconnects and random access memory in DSM systems.

It is a further object of the present invention to provide a method and system for a transparent DSM implementation extending the concept of inode-mapped shared memory segments to refer to remotely available segments.

It is a still another object of the present invention to provide a method and system for identifying and eliminating false sharing problems in DSM environments.

It is a still further object of the present invention to provide a method and system for preventing the problems of access VM-page faults.

Other objects and advantages of the invention will become apparent as the description proceeds.

### SUMMARY OF THE INVENTION

The following terms are defined as follows:

Van Neumann machine: types of computers which use the same RAM for program and data storage.

Proxy Server: A process for providing a cache of items available on other servers.

In one aspect the present invention is directed to a method and system for identifying and eliminating false VM-page sharing in DSM systems by determining false VM-page sharing instances whenever the same VM-page is required for accessing different objects residing on the VM-page, splitting the falsely shared VM-pages into a plurality of smaller VM-pages each of which includes at least one of the objects, setting the falsely shared VM-pages invalid, and whenever receiving a request for one of the falsely shared VM-pages determining which object need to be accessed and accordingly providing one of the smaller VM-pages.

The splitting of the falsely shared VM-pages is preferably carried out until no further false VM-page sharing instances occurs, and the false sharing may be determined according to the queue of requests for each VM-page and by checking the VM-page faulting memory references for the same VM-page.

The determining of the false VM-page sharing instances may further comprise providing an array of faulting locations for each VM-page for logging the faulty locations instances which had occurred within a predetermined time-frame, wherein false sharing is determined whenever identifying repeated access requests to the same page which results in at least two queues for memory references, which are having similar time distribution.

The mode of operation of the CPU may be changed into the single stepping mode whenever receiving a request for one of the falsely shared VM-pages, which allows resetting the memory accessing instructions with the correct memory references of one of the smaller VM-pages. Alternatively, faulting instructions may be emulated whenever a VM-page fault occurs which allows setting the CPU registers with the results of the emulated CPU registers.

In another aspect the present invention is directed to a method and system for managing VM-pages in a DSM system, comprising:
providing each node with a Proxy for intermediating VM-pages transfers and for monitoring and controlling the access permissions of each copied VM-page;
providing each cluster with at least one Master for managing the nodes access to VM-pages and controlling the state of each accessed VM-page, where the Master is capable of communicating with the Proxies over a Data Network;
sending the Master a request for required VM-pages via the node's Proxy whenever such pages are not locally available to the node;
parsing the received requests by the Master and checking the state of each requested VM-page and accordingly determining whether the VM-page can be accessed by the requesting node; and
if it is determined that the VM-page can be accessed by the requesting node sending a copy of the VM-page to the requesting node and updating the status of the page accordingly.

Each Proxy may further include at least one State Machine for controlling the state of each VM-page maintained by it, where the State Machine preferably includes an Invalid-state, a RO-state, and a RW-state, and wherein transitions between the states preferably occurs in respond to messages received from the Master and from the VM of the node.

The transitions into the Invalid-state preferably occurs whenever the Master commands to transfer the VM-page to another node with RW permissions and the state of the State Machine is in the RO-state or in the RW-state, or whenever the Master commands to change the state of the State Machine into the Invalid-sate and it is in the RO-state, where the State Machine remains in the Invalid-state when the proxy requests from the Master permission to access the VM-page with RW or RO permissions.

The transitions into the RO-state preferably occurs whenever the VM-page is transferred to the node with RO permission and the state of the State Machine is in the Invalid-state, or whenever the Master commands to transfer the VM-page to another node with RO permission and the state of the State Machine is in the RW-state, where the State Machine remains in the RO-state when the Master commands to transfer the VM-page to another node with RO permissions.

The transitions into the RW-state preferably occurs whenever the Master commands to change the state of the State Machine into the RW-state and it is in the RO-state, or whenever the state of the State Machine is in the Invalid-state and—
the VM-page is transferred to the node with RW permission; or
the Master commands to change the state of the State Machine into the RW-state for the first time,
   where the State Machine remains in the RW-state when the Master commands to change its state into the RW-state.

Each proxy may further include at least one State Machine for monitoring pending requests from the Master, where the State Machine preferably includes at least a Not-Waiting-state, a Waiting-RO-state, and a Waiting-RW-state, and wherein transitions between the states preferably occurs in respond to messages received from the Master and from the node VM.

The transitions into the Not-Waiting-state preferably occurs whenever the State Machine is in the Waiting-RW-state and—
the VM-page is transferred to the node with RW permission;
the Master commands to delete the VM-page, or to change the state of the State Machine into the RW-sate or into the Invalid-state;
   or whenever the state of the State Machine is in the Waiting-RO-state and—
the VM-page is transferred to the node with RO permission; or
the Master commands to delete the VM-page, or to change the state of the State Machine into the Invalid-state.

The transitions into the Waiting-RO-state preferably occurs whenever the state of the State Machine is in the Not-Waiting-state and the proxy requests from the Master permission to access the VM-page with RO permission, where the State Machine remains in the Waiting-RO-state when the Master commands to change its state into the RW-state.

The transitions into the Waiting-RW-state preferably occurs whenever the proxy requests from the Master permission to access the VM-page with RW permission and the state of the State Machine is in the Not-Waiting-state or in the Waiting-RO-state, where the State Machine remains in the Waiting-RW-state when the proxy requests from the Master permission to access the VM-page with RO permission or when the VM-page is transferred to the node with RO permission.

Each Master may further include at least one State Machine for each copied VM-page for controlling the access of the nodes to the VM-page, where the State Machine preferably includes an Initial-state, a RW-state, a RW-Transit-state, a RO-state, a RO-Transit-state, and a RO-Countdown-state, and wherein transitions between the states preferably occurs in respond to messages received from the Master and from the node VM. The State Machines of new pages are preferably initiated in the Initial-state.

The transitions into the RW-state preferably occurs whenever the Master commands to change the state of the State Machine into the RW-state and it is in the Initial-state, in the RO-state, or in the RO-Countdown-state, or when the State Machine is in the RW-Transit-state and it is acknowledged that the VM-page was transferred to another node which requested it, where the State Machine remains in the RW-state when the Master further commands to change its state into the RW-state.

The transitions into the RW-Transit-state preferably occurs whenever the Master commands to change the state of the State Machine into the RW-state and it is in the RW-state, in the RO-Countdown-state, or in the RO-state.

The transitions into the RO-Transit-state preferably occurs whenever the Master commands to change the state of the State Machine into the RO-state and it is in the RW-state or in the RO-state.

The transitions into the RO-state preferably occurs whenever the state of the State Machine is in the RO-Transit-state and it is acknowledged that the VM-page was transferred to another node which requested it.

The transitions into the RO-Countdown-state preferably occurs whenever the State Machine is in the RO-state and there are more than one node having RO permission to the VM-page and the Master commands to transfer the VM-page to another node with RW permission, where the State Machine remains in the RO-Countdown-state until all the other nodes acknowledge that the state of the State Machine of the corresponding VM-page is changed into the Invalid-state.

The Master may further include:
a Communication Agent for managing the communications between the Master and the Proxies;
a Transport Agent for handling communication between the Master and the proxies and between the Proxies;
a Page Dispatcher for requesting access permissions for each requested VM-page and updating the respective State Machines and for sending requested VM-pages to the requesting nodes via the Transport Agent; and/or
a Memory Manager for passing VM-page requests, which may include additional information, to the Page Dispatcher for verifying that the VM-pages can gain the requested permissions, and for changing the access flag of the VM-pages accordingly upon receiving a respond to the requests.

The Communication Agent may receive and parse VM-page requests for extracting commands and passing them to the State Machine of the Master. The additional information passed by the Memory Manager may include a list of processes that are waiting for the VM-page.

The State Machine of the Master may further comprise a predetermined policy including a set of rules influencing the change of states in the State Machine

### BRIEF DESCRIPTION OF THE DRAWINGS

In the drawings:

FIG. 1 is a block diagram illustrating the false sharing problem in Conventional DSM implementations;

FIG. 2A is a block diagram illustrating page splitting according to a preferred embodiment of the invention;

FIG. 2B is a block diagram illustrating a shared memory implementation according to a preferred embodiment of the invention;

FIGS. 3A-B are state machine diagrams illustrating a preferred embodiment of the Proxies state machines;

FIG. 4 is a state machine diagram illustrating a preferred embodiment of the Master state machine; and

FIG. 5 is a flow chart illustrating VM-page management in a DSM implementation according to a preferred embodiment of the invention.

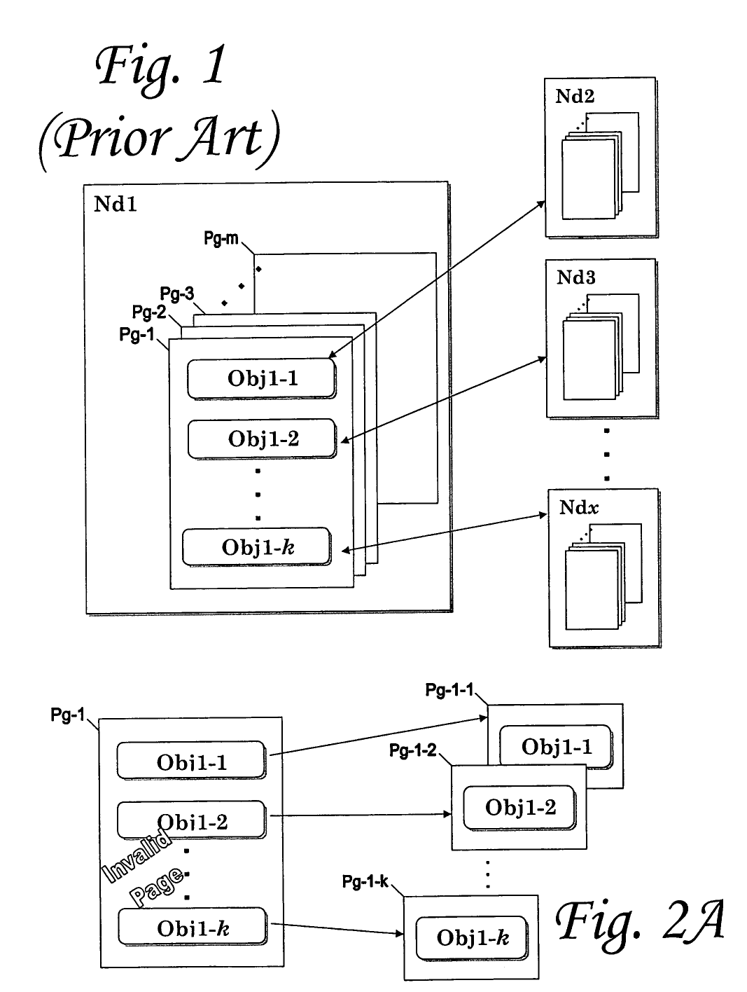

### DETAILED DESCRIPTION OF PREFERRED EMBODIMENTS

The present invention relates to a mechanism for eliminating the false sharing problem in DSM environments. In general the invention consists of false sharing identification and page splitting which includes moving each falsely shared object into its own memory container (a VM-page). Consequently, the splitting of the logical objects into separate memory containers results in address space pointers pointing to the memory containers which are no longer valid. This difficulty is also resolved by the present invention as will be discussed in details herein later.

There are at least two possible approaches to handling distributed shared memory: at the application-level or at the Kernel-level. The application-level approach means re-writing system calls related to shared memory, such as shmget, mmap, etc. The Kernel-level approach means modifying the Kernel's Memory Management (MM, i.e., the VM) to facilitate DSM, leaving the higher levels intact.

It was realized that the Kernel-level approach is preferable for the following reasons:
Localization: only the memory management (actually, page handling) routines should be modified. The application level approach would mean percolation of changes through several levels of abstraction from (numerous) system calls down to the Kernel.
Abstraction: the Kernel approach involves less risks of neglecting the necessary abstraction from a particular application framework.
Reuse: the VM-page faulting mechanisms are already present in the VM. Therefore, there is no need to modify these mechanisms.
Transparency: there is no need to modify new entities, such as IPC shared memory segments or descriptors. All the operations are carried out on memory pages, in a similar fashion as with regular memory operations.

The Kernel-level distributed shared memory is limited to memory pages as handled by the Kernel. Thus, the Kernel handles memory requests in a usual fashion, and the DSM subsystem is invoked only when the Kernel does not find the needed VM-page.

In the preferred embodiment of the invention the dynamics of the Operating System (OS) as it services virtual memory requests, as well as the queuing theory which slows down DSM operation as false sharing occurs, are considered. False sharing by its very nature can be avoided if memory containers for object aren't shared between instantiating execution instances (i.e., processes and threads). True sharing is obviously inherently impossible to avoid totally, but certain alleviating technologies exist already (i.e., lazy release consistency protocol.)

Generally, the factors influencing VM-page fault resolution times are—
i) context switch latency;
ii) page resolution; and
iii) re-scheduling latency.

Since no swap-out of shared memory VM-pages is foreseen the resolution time is on-average almost static.

Therefore, the cost of VM-page fault resolution in a distributed shared memory environment can be summed as follows:
cost=S·c₁+F·c₂+K·c₃

Where S is the number of system calls needed for accessing a VM-page in memory, and c₁ is the cost of making a system call in micro seconds, F is the number of VM-page faults (where page is not in memory and needed to be retrieved from disk) and c₂ is the cost of disk access in microseconds, and K is the number of VM-page copies over the network and c₃ is the cost of copying a VM-page over the network in microseconds.

Mathematically, one way to look at the VM-page fault resolution times under false sharing conditions can be described as a queue for each VM-page with contention. In this context, the queue can be described as having batch arrivals, with non-uniform arrival time distribution, and with a potentially infinite number of new entries at the end of the queue. The queue service mechanism which was previously discussed is well-known and static.

In the VM-page fault queuing mechanism τₙ is the arrival time between the 1^{st} request and the n-th request. Furthermore, τₙ is a random variable and τₙ, n>1 is a stochastic process. Therefore, it follows that inter-arrival times are identically distributed and have a common mean—
E[τₙ]=E[τ]=1/λ
where λ is the arrival rate.

The queue behavior means that no matter what speed-ups will be brought to the VM-page faulting resolution, impediments like true sharing and false sharing will just increase the frequency of VM-page faults requests but not decrease overall application execution time.

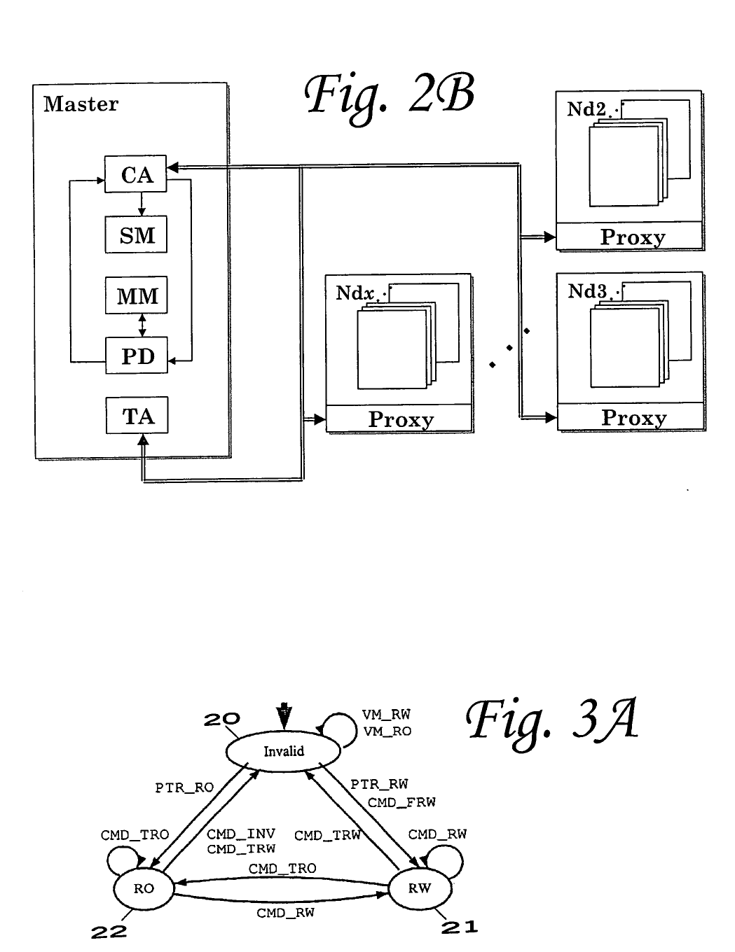

It is therefore highly desirable to devise means to eliminate false sharing altogether. A preferred solution according to the present invention is illustrated in FIG. 2A. The present invention provides a method and system for splitting pages (e.g., Pg-1) into smaller units (Pg-1-1, . . . , Pg-1-k) for storing each shared memory object (Obj1-1, . . . , Obj1-k) in its own memory container. Upon splitting a memory container into smaller memory containers and by transferring each container into a new VM-page, the relevant VM-page (e.g., old VM page Pg-1) is set invalid.

Van Neumann machines, however, necessarily use memory references. Consequently, moving memory objects into new memory containers will result in invalid pointers. Additionally, changing the pointers directly in the program address space is both undesirable and dangerous (the binary running in the address space could be a self-modifying program).

These difficulties are preferably resolved as follows:
CPU emulation: On VM-page fault (i.e., if attempting to access the old VM-page), the faulting instruction is emulated for the executing program and the results of the emulated CPU registers are set on the real CPU registers. This method is generally difficult to implement due to the extraordinary difficulty of properly emulating a complex CPU such as the Intel Pentium. Furthermore, for each instruction to be emulated, several hundred or thousand real instructions will have to be executed by this mechanism. Research in this area showed that the cost of this method very negatively impact the advantages of finer grained memory containers; and/or
CPU single stepping: Modern CPUs like the Intel Pentium series have the ability to be put into a mode whereby instructions are executed one at a time (often used for debugging purposes). Upon each step the CPU registers can be inspected/modified. This method is easier and far more elegant as it dose not require the use of a complex emulator and has only minimum performance impact.

Obviously, the single stepping method is found to be preferable. Therefore, upon splitting the original VM-page (e.g., Pg-1) into several smaller VM-pages and setting it invalid, the CPU is set into single stepping mode and the memory accessing instructions are reset with the correct memory references. This is preferably carried out by adjusting memory references in the faulting instruction and in the faulting instruction only, and for this VM-page fault only. It should be noted however that the same instruction for the same faulting VM-page may be adjusted differently if necessary in the future.

It is important to determine when a false sharing situation occurs. According to the queue theory application discussed above, a sure sign of false sharing is τₙ, increasing near-linearly. A further check on the VM-page faulting memory references for the same VM-page will indicate if it is a true or false sharing situation. In a preferred embodiment of the invention the history of page faulting locations within the VM-page over a span of a few seconds is maintained. In the case of a true sharing such a further check should determine that the same VM-page location was addressed by the different requests.

The memory required for keeping the history per VM-page queue, is however, significant (in the order of τₙ*n*P, where P is the requirements in bytes per historical item.) Due to the huge number of VM-pages present in a modern computer system (millions or billions of VM-pages) only very few historical items can be kept per VM-page. This difficulty is substantially alleviated by maintaining a binary compressed array of the historical items attached to a page table entry.

In a preferred embodiment of the invention the falsely shared memory containers are split into 2 until the false sharing situation expires. The DSM implementation includes two main subsystems: Master (one per cluster) and Proxies (one Proxy Server per node), as shown in FIG. 2B. In this way a simple maintenance of the state machine of the DSM is attained. The proxies are responsible for distributing the DSM logic and thereby to eliminating the need for a central and un-scalable state machine maintainer. Furthermore each proxy keeps a cache of recently used VM-pages which have been received from remote nodes.

FIG. 2B is a block diagram illustrating a system for managing VM-pages in a DSM implementation according to a preferred embodiment of the invention. The Master includes a Communication Agent (CA), a State Machine (SM), a Memory Manager (MM), a Page Dispatcher (PD), and a Transport Agent (TA). The CA handles the Master's communications with the Proxies. The received messages (or, alternatively, their payloads without the headers) are parsed by the CA and the resulting commands are passed to the Master's SM. The parser handles a finite number of distinct messages according to the specified protocol.

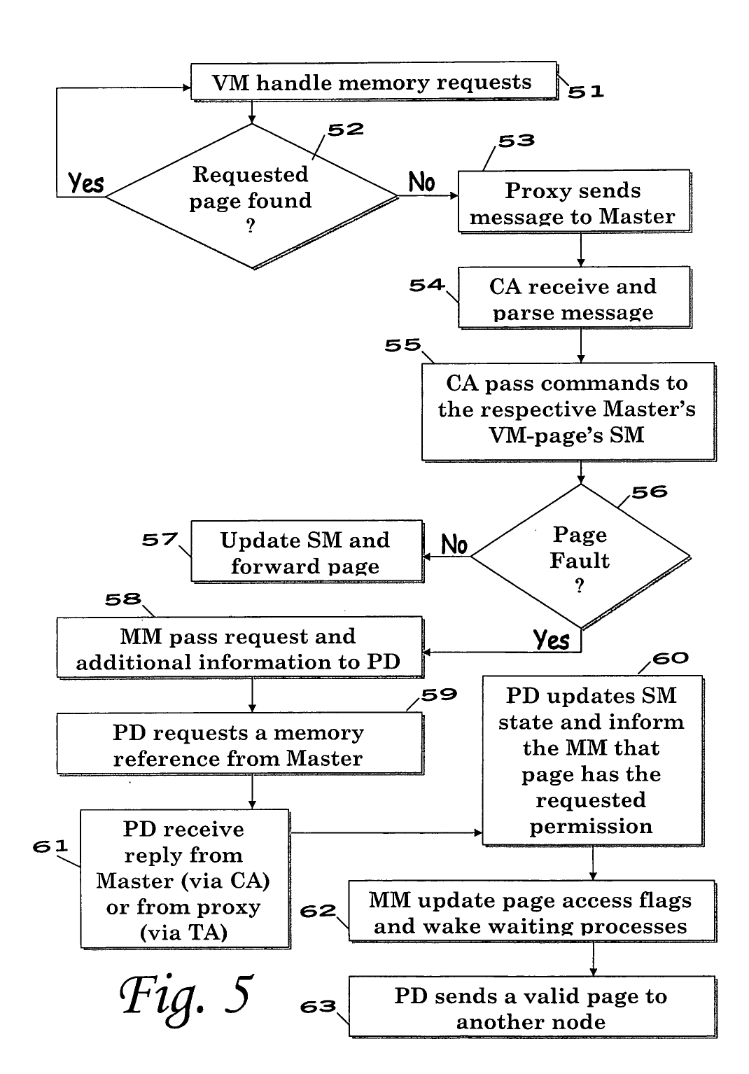

FIG. 5 is a flowchart exemplifying VM management in a DSM implementation according to a preferred embodiment of the invention. As exemplified in steps 51-52, the Kernel (the VM) handles memory requests in a usual fashion, and the DSM subsystem is invoked only when the Kernel does not find the needed VM-page. Whenever a requested VM-page is not found by the VM of the node, in step 53 a message requesting the missing VM-page is sent by the Proxy to the Master. In steps 54-55 the CA receives and parse the sent message and pass the commands included therein to the respective VM-page SM of the Master.

The SM is the heart of the Master. For each allocated VM-page it keeps track of which nodes are accessing it in Read-Only (RO) or Read-Write (RW) modes. For each request the accountant (i.e., the SM maintainer) consults the appropriate policy (a set of rules influencing the change of states in the SM) as defined by the user or programmer, changes the VM-page's state in the SM, and sends “grant” or command messages to one or more nodes (not necessarily to the node that made the request.). Such policy may be for instance stating FIFO with lease time of 0.1 millisecond.

The VM is the only part of the Kernel that needs to be modified. According to a preferred embodiment of the invention every node within a cluster can serve as a master and/or a proxy, which means that the Kernel of each and every participating node in the cluster is preferably modified. The operation of the modified VM is very similar to standard Linux swapping mechanism (i.e., kswapd).

All VM-pages memory requests in the cluster are processed as usual, with the only exception that a VM-page fault occurs if a DSM page is requested. If no VM-page fault occurs (i.e., the requested page was not identified as being falsely shared), then in steps 56 and 57 the required permissions of the VM-page are set by the VM, the SM related to the page is modified accordingly, and the VM-page is forwarded to the requesting node utilizing conventional communication routes. If a VM-page fault occurs, in step 58 the MM passes the request together with some additional information, such as a list of processes that are waiting for the VM-page, to the PD.

In step 59, upon being woken up by the MM, the PD composes a request for a certain memory location required by an executing instance to the Master, and passes it to the CA. The reply received in step 61 may come either from the Master via the CA (e.g., grant of allocation or access request) or from another Proxy via the TA. In either case, in step 60 the PD updates the SM state of the respective VM-page and notifies the MM that the processes waiting for the page can be awakened.

Once the PD informs the MM that the requested page has the requested permissions, according to the SM state, in step 62 the MM marks the page access flags appropriately and wakes the waiting processes. Finally, upon receiving a command from the Master, in step 63 the PD sends a valid existing page to another node via the TA.

The TA handles all the Proxy communications: both the Proxy Master channel and the page exchange between Proxies. This is an abstraction layer that separates the actual implementation of a transport mechanism from the actual DSM operations performed by the PD.

Obviously, it is not worthwhile to bother the Master with every process request for reading from or for writing to a memory page, and thus in the preferred embodiment of the invention the Proxies maintain their own per page SM, with all the ensuing consistency issues.

FIGS. 3A and 3B illustrate the Proxies' SMs. The transitions between the states are marked according to the Proxy-Master and Proxy-Proxy protocol messages Each Proxy maintains two SMs per used VM-page. These SMs are typically simpler than that of the Master, because the Proxies have only local knowledge of the state of the VM-page.

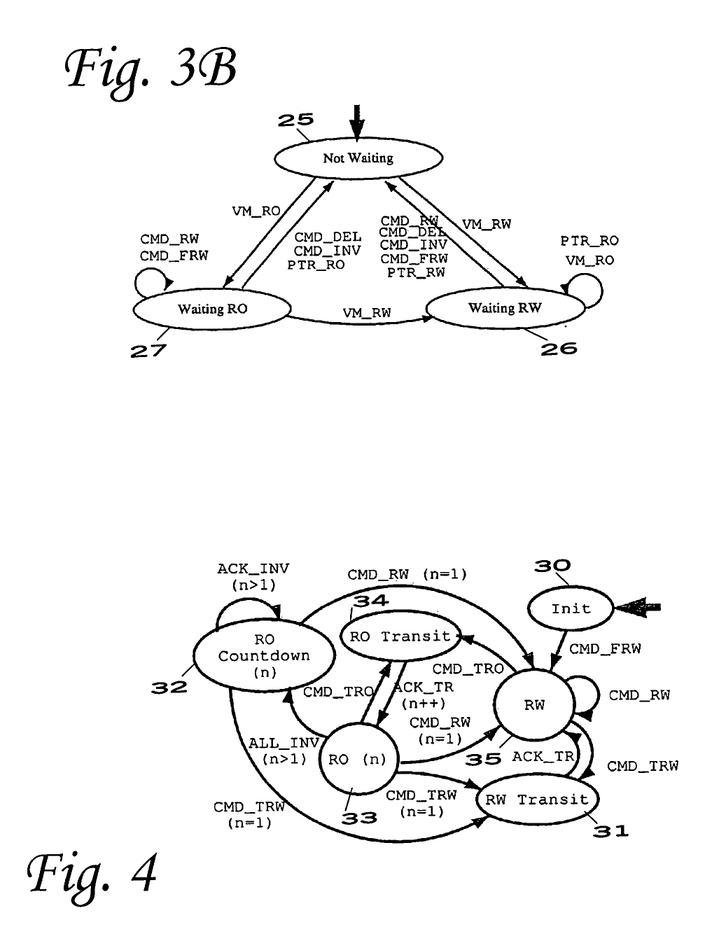

The protocol messages in FIGS. 3A-B and FIG. 4 are as follows:
PTR_RO—Page Transferred from another node with RO permissions;
PTR_RW—Page Transferred from another node with RW permissions;
VM_RW—Proxy requested the page with RW permissions;
VM_RO—Proxy requested the page with RO permissions;
CMD_FRW—Command to change page permission to RW for the first time;
CMD_FRO—Command to change page permission to RO for the first time;
CMD_RW—Command to change page permission to RW;
CMD_RO—Command to change page permission to RO;
CMD_TRO—Command to Transfer the Page with RO permissions;
CMD_TRW—Command to Transfer the Page with RW permissions;
CMD_NV—Command to change page state to the Invalid state;
CMD_DEL—Command to destroy the page;
ACK_TR—Page Transfer is Acknowledged by the receiving Proxy;
ACK_INV—Acknowledgement that the Page is in Invalid state;

The two SMs correspond to the state of a VM-page (FIG. 3A) and the pending requests from the Master (FIG. 3B). The SM shown is FIG. 3A is used for granting permissions to the VM, and the SM shown is FIG. 3B is used for keeping track of requests received from the Master in order to allow several processes to request the page (through the VM), such that only one request is forwarded to the Master at any given time.

The page states of the SM shown in FIG. 3A, are as follows:
Invalid (20): this state is attained when a Proxy invalidates a VM-page that was in the Read-Only (RO, 22) or in the Read-Write (RW, 21) state, which occurs whenever the VM-page is transferred with RW permissions (CMD_TRW). Whenever a VM-page is transferred by the Proxy with RW permissions, the state of the corresponding VM-page SM is set to the Invalid (20) state, since another node might be writing into it. Therefore, the state of a VM-page is changed to a RO (22) or RW (21) state from the Invalid (20) state only when the VM-page is transferred from another node (PTR_RO or PTR_RW). The Master has to make sure that the transferred copy is valid. A special case is when a VM-page is created in the Invalid (20) state. After it is created, there is no sense in reading from the VM-page and thus its state can be changed to the RW (21) state (CMD_FRW).
RO (22): The Proxy holds RO permissions on the VM-page. This state can be reached when the VM-page is copied from another node with RO permissions or when the Proxy is instructed to switch from the RW (21) state to the RO (22) state (CMD_TRO) in order to transfer the VM-page to another node with RO permissions. It should be noted that there is no reason to switch from the RW (21) state to the RO (22) state unless the VM-page is transferred to another node, since the state of the VM-page can be changed to be writable then. The SM state of course remains in the RO (22) state if the Proxy is further instructed to switch to the RO (22) state (CMD_TRO)
RW (21): the Proxy holds Read-Write permissions of the VM-page. This state can be reached from the Invalid (20) state when the Master instructs another Proxy to transfer the VM-page to the Proxy with RW permissions (PTR_RW), or when the VM-page has just been created and is first made writable (CMD_FRW). The Proxy does not change the VM-page state if it gets CMD_RW from the Master. This may happen if there are multiple requests from the VM for a VM-page in the Invalid (20) state before the Proxy gets permission to switch to the RW state (21).

A VM-page can be destroyed in any state when a Proxy receives a msgDELETE COMMAND (CMD_DEL) from the Master. If a message does not trigger a valid transition to one of the states shown in FIG. 3A, it is considered a fatal error.

The VM-page states of the second SM of the Proxy, shown in FIG. 3A, are as follows:
Not Waiting (25): this state is the “normal” state for a VM-page. Namely, the Proxy does not have any pending requests from Master;
Waiting RO (27): this state is typically reached after the Proxy has requested a VM-page with RO permissions from the Master (VM_RO). Further requests from the VM for RO permission on the same VM-page while it is in this state will be ignored. When the VM-page arrives (CMD_INV), the state of the SM is changed into the Not Waiting (25) state. If a request from the proxy for RW permission arrives (VM_RW), no request is sent to the Master, and the state of the SM is changed into the Waiting RW (26) state;
Waiting RW (26): this state is typically reached either when the Proxy has requested a VM-page with RW permissions (VM_RW) from the Master, or when it has requested a VM-page with RO permissions (VM_RO) from the Master and got a request from the VM for RW permissions (VM_RW). When a VM-page with RO permissions arrives, the Proxy requests RW permissions (VM_RW). When the VM-page arrives with RW permissions (CMD_DEL), the SM state is changed into the Not Waiting (25) state;

The transitions in Master's SM are triggered according to the Policy's decisions (obtained as the Policy processes the Proxies' requests). However, since the Policy is as yet undetermined, it is convenient to mark the transitions using the messages the Master sends to Proxies at the time when the transition occurs.

The Master maintains a SM for each VM-page with the following states:
Init (30): new VM-pages are created in this state. There is no other way to reach this state since a situation in which the Master revokes all access permissions from all the cluster nodes without destroying the VM-page is not expected to occur. Once the VM-page is created, the only possible transition is to the RW state (35) via CMD_FRW.
RW (35): this state is reached whenever access to the VM-page is granted for writing to only one (and only one) node (CMD_RW(n=1)). While the VM-page is in this state, reqRO or reqRW requests (VM_RW) for accessing the VM-page may arrive from the current writer node (if the writer's VM manages to request access more than once before state change is in effect). The Master will only confirm to the Proxy that the permissions are in place by sending a CMD_RW command. In effect, this is an extra synchronization message.
RW Transit (31): a VM-page attains this state when the Master sends CMD_TRW to one of the Proxies, and remains there until ACK_TR is received from the Proxy to which the VM-page was sent, whereby the state is changed to the RW (35) state.
RO (33): this is in fact a composite state, since in a cluster of N nodes there can be up to N concurrent readers for every VM-page. This state keeps a counter of the current number of readers i and a list of the readers. The RO (33) state with i=1 is somewhat special: the Master can issue a CMD_RW message (CMD_RW₍ₙ₌₁₎) to the reader to grant it RW permissions, which is typically followed by changing the SM state into the RW (35) state, or a CMD_TRW message (CMD_TRW₍ₙ₌₁₎) which changes the SM state into the RW Transit (31) state until ACK_TR is received from the new writer node, whereby the SM state is changed into the RW (35) state.
RO Countdown (32): this is also a composite state that maintains a counter n of the current number of readers and a list of the readers. It is attained when the Policy directs the Master either to transfer a VM-page to another node with RW permissions (ALL_INV_{(n>1)}), and there are currently n>1 readers, or to give one of the existing readers RW permissions. In either case, the Master sends CMD_INV to all the readers but one (the one that will become the writer or the one that will send the page to the new writer). In FIG. 4 this is indicated by the ALL_INV (n>1) transition. As each reader acknowledges invalidation with ACK_INV, the Master will decrement the number of remaining readers in the RO Countdown (33) state. Once the last ACK_INV is received, the counter's count becomes 1, and the Master issues either CMD_RW (CMD_{—RW}₍ₙ₌₁₎) and the SM state is changed into the RW (35) state (if the last reader becomes the writer), or issues a CMD_TRW command (CMD_TRW₍ₙ₌1)) whereby the SM state is changed into the RW Transit (31) state until the new writer acknowledges receipt of the VM-page with AKC_TR, whereby the state of the SM is changed into the RW (35) state. No requests of any kind will be processed while the page is in this state.
RO Transit (34): this state is attained when the Master sends CMD_TRO to the current writer node or to one of the current reader nodes. The VM-page remains in this state until ACK_TR (ACK_TR₍ₙ₊₊₎) is received from the node to which the VM-page was sent, whereby the SM state is changed into the RO (33) state and the counter of readers is incremented by one. In principle, the Master should be able to process further read requests while the VM-page is in this state, but such a situation complicates the operation because the Master would have to keep track of how many outstanding transfers there are in the system. However, in such a situation the Master would not be able to handle other requests, such as CMD_RW for example. For simplicity, a restriction is imposed that no requests will be handled while the VM-page is in this state.

It should be noted that a VM-page can be destroyed from any state. Typically, the Master sends a CMD_DEL command to all the nodes who have the VM-page (in any state), and destroys every trace of it, including the respective SM. By assumption the command will be executed by all Proxies without further intervention from the Master.

The above examples and description have of course been provided only for the purpose of illustration, and are not intended to limit the invention in any way. As will be appreciated by the skilled person, the invention can be carried out in a great variety of ways, employing techniques different from those described above, all without exceeding the scope of the invention.

1. A method for identifying and eliminating false vm-page sharing in DSM systems, comprising:
a) determining false VM-page sharing instances whenever the same VM-page is required for accessing different objects residing on said VM-page;
b) splitting the falsely shared VM-pages into a plurality of smaller VM-pages each of which includes at least one of said objects;
c) setting said falsely shared VM-pages invalid; and
d) whenever receiving a request for one of said falsely shared VM-pages determining which object need to be accessed and accordingly providing one of said smaller VM-pages.

2. A method according to claim 1, wherein falsely shared VM-pages are splitted until no further false VM-page sharing instances occurs.

3. A method according to claim 1, wherein false sharing is determined according to the queue of requests for each VM-page and by checking the VM-page faulting memory references for the same VM-page.

4. A method according to claim 1, further comprising providing an array of faulting locations for each VM-page for logging the faulty locations instances which had occurred within a predetermined time-frame, wherein false sharing is determined whenever identifying repeated access requests to the same page which results in at least two queues for memory references, which are having similar time distribution.

5. A method according to claim 1, further comprising changing the CPU mode of operation into the single stepping mode whenever receiving a request for one of the falsely shared VM-pages and resetting the memory accessing instructions with the correct memory references of one of said smaller VM-pages.

6. A method according to claim 1, further comprising emulating faulting instructions for the executing program whenever a VM-page fault occurs and setting the CPU registers with the results of the emulated CPU registers.

7. A method for managing VM-pages in a DSM system, comprising:
a) providing each node with a Proxy for intermediating VM-pages transfers and for monitoring and controlling the access permissions of each copied VM-page;
b) providing each cluster with at least one Master for managing the nodes access to VM-pages and controlling the state of each accessed VM-page, where said Master is capable of communicating with said Proxies over a Data Network;
c) sending said Master a request for required VM-pages via the node's Proxy whenever such pages are not locally available to the node;
d) parsing the received requests by the Master and checking the state of each requested VM-page and accordingly determining whether said VM-page can be accessed by the requesting node; and
e) if it is determined that said VM-page can be accessed by the requesting node sending a copy of said VM-page to the requesting node and updating the status of said page accordingly.

8. A method according to claim 6, further comprising providing each Proxy with at least one State Machine for controlling the state of each VM-page maintained by it, where said State Machine includes an Invalid-state, a RO-state, and a RW-state, and wherein transitions between said states occurs in respond to messages received from the Master and from the VM of the node.

9. A method according to claim 8 comprising transiting into the Invalid-state whenever the Master commands to transfer the VM-page to another node with RW permissions and the state of the State Machine is in the RO-state or in the RW-state, or whenever the Master commands to change the state of said State Machine into the Invalid-sate and it is in the RO-state, where said State Machine remains in the Invalid-state when the proxy requests from the Master permission to access said VM-page with RW or RO permissions.

10. A method according to claim 8 comprising transiting into the RO-state whenever the VM-page is transferred to the node with RO permission and the state of the State Machine is in the Invalid-state, or whenever the Master commands to transfer said VM-page to another node with RO permission and the state of said State Machine is in the RW-state, where said State Machine remains in the RO-state when the Master commands to transfer said VM-page to another node with RO permissions.

11. A method according to claim 8 comprising transiting into the RW-state whenever the Master commands to change the state of the State Machine into the RW-state and it is in the RO-state, or whenever the state of said State Machine is in the Invalid-state and—
said VM-page is transferred to the node with RW permission; or
the Master commands to change the state of said State Machine into the RW-state for the first time,
where said State Machine remains in the RW-state when the Master commands to change its state into the RW-state.

12. A method according to claim 6, further comprising providing each proxy with at least one State Machine for each VM-page maintained by it for monitoring pending requests from the Master, where said State Machine includes at least a Not-Waiting-state, a Waiting-RO-state, and a Waiting-RW-state, and wherein transitions between said states occurs in respond to messages received from the Master and from the node VM.

13. A method according to claim 12, further comprising consulting a predetermined policy including a set of rules influencing the change of states in the State Machine.

14. A method according to claim 12 comprising transiting into the Not-Waiting-state whenever the State Machine is in the Waiting-RW-state and—
the VM-page is transferred to the node with RW permission;
the Master commands to delete said VM-page, or to change the state of said State Machine into the RW-sate or into the Invalid-state;
or whenever the state of said State Machine is in the Waiting-RO-state and—
the VM-page is transferred to the node with RO permission; or
the Master commands to delete said VM-page, or to change the state of said State Machine into the Invalid-state.

15. A method according to claim 12 comprising transiting into the Waiting-RO-state whenever the state of the State Machine is in the Not-Waiting-state and the proxy requests from the Master permission to access the VM-page with RO permission, where said State Machine remains in the Waiting-RO-state when the Master commands to change its state into the RW-state.

16. A method according to claim 12 comprising transiting into the Waiting-RW-state whenever the proxy requests from the Master permission to access the VM-page with RW permission and the state of the State Machine is in the Not-Waiting-state or in the Waiting-RO-state, where said State Machine remains in the Waiting-RW-state when the proxy requests from the Master permission to access said VM-page with RO permission or when said VM-page is transferred to the node with RO permission.

17. A method according to claim 1, further comprising providing each Master with at least one State Machine for each copied VM-page for controlling the access of the nodes to said VM-page, where said State Machine includes an Initial-state, a RW-state, a RW-Transit-state, a RO-state, a RO-Transit-state, and a RO-Countdown-state, and wherein transitions between said states occurs in respond to messages received from the Master and from the node VM.

18. A method according to claim 17 comprising initiating the State Machines of new pages in the Initial-state.

19. A method according to claim 17 comprising transiting into the RW-state whenever the Master commands to change the state of the State Machine into the RW-state and it is in the Initial-state, in the RO-state, or in the RO-Countdown-state, or when the State Machine is in the RW-Transit-state and it is acknowledged that the VM-page was transferred to another node which requested it, where said State Machine remains in the RW-state when the Master further commands to change its state into the RW-state.

20. A method according to claim 17 comprising transiting into the RW-Transit-state whenever the Master commands to change the state of the State Machine into the RW-state and it is in the RW-state, in the RO-Countdown-state, or in the RO-state.

21. A method according to claim 17 comprising transiting into the RO-Transit-state whenever the Master commands to change the state of the State Machine into the RO-state and it is in the RW-state or in the RO-state.

22. A method according to claim 17 comprising transiting into the RO-state whenever the state of the State Machine is in the RO-Transit-state and it is acknowledged that the VM-page was transferred to another node which requested it.

23. A method according to claim 17 comprising transiting into the RO-Countdown-state whenever the State Machine is in the RO-state and there are more than one node having RO permission to said VM-page and the Master commands to transfer said VM-page to another node with RW permission, where said State Machine remains in the RO-Countdown-state until all said other nodes acknowledge that the state of the State Machine of the corresponding VM-page is changed into the Invalid-state.

24. A system for managing VM-pages in a Distributed Shared Memory implementation, comprising one or more proxies each of which maintains the VM-pages recently used by a node, and at least one Master capable of communicating with said Proxies over a Data Network for managing the VM-pages in the system,
wherein said proxies sends said Master requests for VM-pages whenever said VM-pages are not locally available to the node, and said Master sends a copy of said VM-page to the requesting node and updates its status accordingly whenever it determines that said VM-page can be accessed by the requesting node.

25. A system according to claim 24, further comprising at least one State Machine managed by the proxies for controlling the state of each VM-page maintained by it, where said State Machine includes an Invalid-state, a RO-state, and a RW-state, and wherein transitions between said states occurs in respond to messages received from the Master and from the node VM.

26. A system according to claim 24, further comprising at least one State Machine managed by the proxies for each VM-page it maintains for monitoring pending requests from the Master, where said State Machine includes at least a Not-Waiting-state, a Waiting-RO-state, and a Waiting-RW-state, and wherein transitions between said states occurs in respond to messages received from the Master and from the node VM.

27. A system according to claim 24, further comprising at least one State Machines managed by the Master for each copied VM-page for controlling the access of the nodes to said VM-page, where said State Machine includes an Initial-state, a RW-state, a RW-Transit-state, a RO-state, a RO-Transit-state, and a RO-Countdown-state, and wherein transitions between said states occurs in respond to messages received from the Master and from the node VM.

28. A system according to claim 27, further comprising a predetermined policy including a set of rules influencing the change of states in the State Machine

29. A system according to claim 24, wherein the Master includes a Communication Agent for managing the communications between the Master and the Proxies.

30. A system according to claim 27 claims 27 and 29, wherein the VM-page requests are received and parsed by the Communication Agent for extracting commands and passing the same to the State Machine of the Master.

31. A system according to claim 24, wherein the Master includes a Transport Agent for handling communication between the Master and the proxies and between the Proxies.

32. A system according to claim 31, wherein the Master includes a Page Dispatcher for requesting access permissions for each requested VM-page and updating the respective State Machines and for sending requested VM-pages to the requesting nodes via the Transport Agent.

33. A system according to claim 32, wherein the Master includes a Memory Manager for passing VM-page requests to the Page Dispatcher for verifying that said VM-pages can gain the requested permissions, and for changing the access flag of the VM-pages accordingly upon receiving a respond to said requests.

34. A system according to claim 33, wherein the VM-page requests includes additional information.

35. A system according to claim 34, wherein the additional information includes a list of processes that are waiting for the VM-page.

36. A system according to claim 28, wherein the VM-page requests are received and parsed by the Communication Agent for extracting commands and passing the same to the State Machine of the Master.

37. A system according to claim 29, wherein the VM-page requests are received and parsed by the Communication Agent for extracting commands and passing the same to the State Machine of the Master.
